(19) United States
(12) Patent Application Publication
(10) Pub. No.: US 2023/0367894 A1
(43) Pub. Date: Nov. 16, 2023

(54) REMOTE LESSON SUPPORT SYSTEM, METHOD, AND PROGRAM

(71) Applicant: KONICA MINOLTA, INC., Tokyo (JP)

(72) Inventor: Natsumi TAMON, Itami-shi (JP)

(73) Assignee: KONICA MINOLTA, INC., Tokyo (JP)

(21) Appl. No.: 18/313,758

(22) Filed: May 8, 2023

(30) Foreign Application Priority Data
May 12, 2022 (JP) 2022-078957

(51) Int. Cl. G06F 21/62; H04L 65/1089; H04L 65/1059; H04L 65/403; G09B 5/02; G09B 5/10

(52) U.S. Cl. CPC G06F 21/6218; H04L 65/1089; H04L 65/1059; H04L 65/403; G09B 5/02; G09B 5/10

(57) ABSTRACT

A remote lesson support system that supports a remote lesson in which a plurality of learners participates via a network, includes: a first terminal operated by a first learner; a second terminal operated by a second learner; and a server that is communicably connected to the first terminal and the second terminal and provides an environment of the remote lesson, wherein the server includes a processing device that sets a secret mode that restricts information of the first learner from being provided to the second terminal.

The entire disclosure of Japanese patent Application No. 2022-078957, filed on May 12, 2022, is incorporated herein by reference in its entirety.

### BACKGROUND

### Technological Field

The present disclosure relates to a remote lesson support system, a method, and a program, and specifically, to a remote lesson support system, method, and program that support a remote lesson.

### Description of the Related Art

Conventionally, there has been proposed a remote lesson support system that supports a remote lesson in which a plurality of learners attends from a remote place via a network.

JP 2003-280506 A discloses a system that enables a remote lesson by using a display device for a lecturer that displays a face image of a student and a display device for a student that displays face images of a lecturer and other students.

In recent years, remote lessons have been actively conducted due to rapid progress of network technology. The remote lesson has a feature that the learner does not need to directly go to a lesson location. Therefore, the remote lesson brings a benefit to a learner who is difficult to go to a lesson location due to various circumstances.

The remote lesson further has a feature that the learner does not need to contact other learners. It is conceivable to take advantage of this feature and utilize the remote lesson as a place of learning for a student who does not like contact with other students or a teacher and stops attending school, for example. However, in the conventional remote lesson system, information of a participant, such as a name, is displayed on a screen of a terminal of another participant. Therefore, it cannot be said that the conventional system is suitable for use by a learner who feels stress from a relationship with others, such as a student who stops attending school.

### SUMMARY

The present disclosure has been made in view of such circumstances, and an object of the present disclosure is to provide a remote lesson in consideration of use by a learner who feels stress in a relationship with others.

To achieve the abovementioned object, according to an aspect of the present invention, there is provided a remote lesson support system that supports a remote lesson in which a plurality of learners participates via a network, and the remote lesson support system reflecting one aspect of the present invention comprises: a first terminal operated by a first learner; a second terminal operated by a second learner; and a server that is communicably connected to the first terminal and the second terminal and provides an environment of the remote lesson, wherein the server includes a processing device that sets a secret mode that restricts information of the first learner from being provided to the second terminal.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an overall configuration of a lesson support system;

FIG. 2 is a block diagram showing a hardware configuration of a management server;

FIG. 3 is a block diagram showing a functional configuration of the management server;

FIG. 4 is a diagram for describing an instructor setting screen;

FIG. 5 is a diagram for describing an instructor screen (in a case where private setting is not set to an instructor);

FIG. 6 is a diagram for describing the instructor screen (in a case where private setting is set to an instructor);

FIG. 7 is a diagram for describing a learner screen corresponding to a user ID=01;

FIG. 8 is a diagram for describing a learner screen corresponding to a user ID=02;

FIG. 9 is a diagram for describing detailed setting items of a secret mode;

FIG. 10 is a diagram showing an example of a setting pattern of the secret mode;

FIG. 11 is a diagram for describing a learner setting screen;

FIG. 12 is a diagram showing a relationship between learner setting and detailed setting;

FIG. 13 is a diagram showing an example of a history of a remote lesson stored in the management server;

FIG. 14 is a diagram showing an example of a history of the remote lesson (for each user ID and for each secret mode pattern) stored in the management server;

FIG. 15 is a diagram showing an example of a history of the remote lesson (for each secret mode pattern (all learners));

FIG. 16 is a flowchart for describing a flow of processing related to setting of the secret mode and generation of a history of the remote lesson;

FIG. 17 is a flowchart for describing a flow of manager setting processing;

FIG. 18 is a flowchart for describing a flow of instructor setting processing;

FIG. 19 is a subroutine for describing a flow of instructor screen generation processing;

FIG. 20 is a subroutine for describing a flow of learner screen generation processing; and

FIG. 21 is a flowchart for describing a flow of participant restriction processing according to a modification.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts and constituent elements are denoted by the same reference signs. The names and functions of the same parts and constituent elements are the same. Therefore, the same parts and constituent elements will not be repeatedly described.

[Overall Configuration of Remote Lesson Support System]

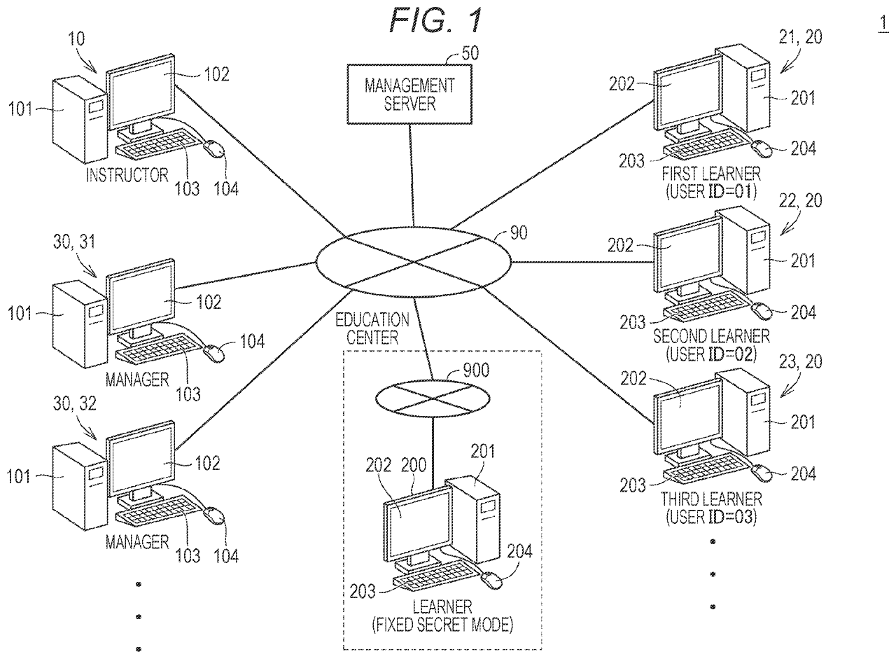

FIG. 1 is a diagram showing an overall configuration of a remote lesson support system 1 according to an embodiment. The remote lesson support system 1 includes a management server 50, an instructor terminal 10, a plurality of learner terminals 21, 22, 23, . . . , a learner terminal 200 installed in a specific base 900, and a plurality of manager terminals 31, 32, . . . . The management server 50 is communicably connected to the instructor terminal 10, the plurality of learner terminals 21, 22, 23, . . . , the learner terminal 200, and the plurality of manager terminals 31, 32, . . . via a network 90.

The management server 50 includes, for example, a cloud server. The instructor terminal 10 includes, for example, a personal computer, and includes a main body 101, a display 102, a keyboard 103, and a mouse 104. The learner terminals 21, 22, 23, . . . and the learner terminal 200 include, for example, a personal computer, and each include a main body 201, a display 202, a keyboard 203, and a mouse 204. The manager terminals 31, 32, . . . each include, for example, a personal computer, and includes a main body 301, a display 302, a keyboard 303, and a mouse 304.

A camera that captures a video image of an operator, a microphone that collects voice of the operator, a speaker that outputs voice of each participant transmitted through the management server 50, and the like are built in the instructor terminal 10, the learner terminals 21, 22, 23, . . . , and the learner terminal 200. The display 102 of the instructor terminal 10 and the display 202 of the learner terminals 21, 22, 23, . . . and the learner terminal 200 display a video of each participant, a worksheet of each participant, and the like transmitted through the management server 50.

Hereinafter, the learner terminals 21, 22, 23, . . . (except for the learner terminal 200) may be collectively referred to as a “learner terminal 20”, and the manager terminals 31, 32, . . . may be collectively referred to as a “manager terminal 30”.

In the present embodiment, the instructor is, for example, a teacher of an elementary school. The instructor may be a middle school or high school teacher, a person in charge of a university lecture, or the like. The instructor may be a person who teaches applicants specialized skills or the like in a private circle or the like. In the present embodiment, the learner participates in remote lesson of the instructor, and is, for example, a student such as a child or a pupil, a participant participating in a circle activity, or the like.

The instructor terminal 10 is operated by an instructor who conducts a remote lesson for a plurality of learners. The instructor accesses the management server 50 by using, for example, the instructor terminal 10 disposed at home.

The learner terminal 20 is operated by a learner who participates in the remote lesson. The learner accesses the management server 50 by using, for example, the learner terminal 20 disposed at home. The learner can also access the management server 50 by using the learner terminal 200 disposed in a specific base 900 such as an education center.

The manager terminal 30 is operated by a manager. The range of manager authority varies depending on the manager. The manager is, for example, a person who manages the management server 50. In addition, the manager is a person who substitutes the learner, such as a parent of the learner. In a case where the instructor is a teacher of an elementary school, the manager may be a supervisor who supervises the teacher, such as a principal of the elementary school.

The management server 50 accepts logins of the instructor terminal 10, the learner terminals 20 and 200, and the manager terminal 30. The management server 50 identifies the instructor, each learner, and each manager by a user ID. The user ID is included in login information to the management server 50.

For example, the learner terminal 21 is operated by a learner identified by a user ID=01. The learner terminal 22 is operated by a learner identified by a user ID=02. The learner terminal 23 is operated by a learner identified by a user ID=03. Hereinafter, the learners identified by the user IDs=01, 02, 03, . . . may be referred to as “first learner”, “second learner”, and “third learner” . . . , respectively.

The management server 50 accepts logins of the instructor terminal 10 and the learner terminals 20 and 200, and provides an environment for the remote lesson between the instructor terminal 10 and the learner terminals and 200. The management server 50 normally provides information such as a name, a face photograph, a video, and a worksheet of a participant in the remote lesson to the instructor terminal 10 and the learner terminals 20 and 200. As a result, the instructor and the learner can know a state of other participants during the remote lesson. The remote lesson support system 1 according to the present embodiment can provide a realistic remote lesson to a participant.

FIG. 1 discloses one instructor terminal 10 as a representative example. However, a plurality of instructor terminals 10 operated by a plurality of instructor having different user IDs are connected to the remote lesson support system 1.

[Outline of Secret Mode]

The management server 50 provides learners, if they desire, with an environment to participate in the remote lesson in a “secret mode”. In the secret mode, the information of the learner targeted for the secret mode to other participants participating in the remote lesson is restricted from being provided. Thus, by using the secret mode, the learner can participate in the remote lesson without the information of the learner, such as the name, the face photograph, and the video, being known to other learners or the instructor.

Therefore, in the present embodiment, it is possible to provide the remote lesson support system 1 capable of promoting use by a learner who feels stress from a relationship with other students, such as a student who does not like contact with other students or the instructor and stops attending school.

A person who sets the secret mode can select items to be private from detailed setting items such as a name, a video, and a voice by using the remote lesson support system 1. Therefore, in the present embodiment, various patterns of secret modes in consideration of the circumstances of a subject are provided. Hereinafter, a mode in which the secret mode is not set may be referred to as a “standard mode” in comparison with the secret mode.

The remote lesson support system 1 according to the present embodiment gives a plurality of persons the authority to set the secret mode, assuming various situations. Specifically, in the present embodiment, each of the instructor, the learner, and the manager is authorized to set the secret mode.

[Setting of Secret Mode by Instructor]

The instructor can set the secret mode for the learner of the remote lesson in charge of the instructor by operating the instructor terminal 10 of the instructor.

[Setting of Secret Mode by Learner]

The learner can set the secret mode for the learner by operating the learner terminal 20 of the learner. For example, the learner can change a lesson mode from the secret mode to the standard mode and change the pattern of the secret mode while participating in the remote lesson in which the instructor has set the secret mode in advance. Conversely, the learner can change the lesson mode from the standard mode to the secret mode during the remote lesson.

[Setting of Secret Mode by Manager]

The manager can set the secret mode within the range of manager authority set in advance. For example, the manager of the manager terminal 31 is a parent of a learner who operates the learner terminal 21. In this case, the manager of the manager terminal 31 is given the manager authority to limit a setting range to the learner who operates the learner terminal 21. Therefore, the manager of the manager terminal 31 can perform setting related to the secret mode of the learner who operates the learner terminal 21 through the manager terminal 31. The manager of the manager terminal 31 is not authorized to perform setting related to the secret modes of other learners.

For example, the manager of the manager terminal 32 may be a supervisor who supervises the instructor. In this case, the manager of the manager terminal 32 may be given manager authority to the learner of the remote lesson in charge of the instructor. In this case, the manager of the manager terminal 32 can perform setting related to the secret mode of each learner who operates the learner terminals 21, 22, 23, . . . through the manager terminal 32.

[Setting of Public/Private to Instructor]

The manager is authorized to set whether to restrict the information of the learner from being provided to the instructor in charge of the remote lesson of the learner targeted for the secret mode. In the remote lesson in which the information of the learner is restricted from being provided to the instructor, the information of the learner targeted for the secret mode and the instructor is restricted from being provided to other learners.

[Friend Setting]

The manager is given a function of performing friend setting for learners included in the range of manager authority. By using the friend setting, the manager can set a person to whom the manager exceptionally sets the information of the learner to public during the remote lesson, such as a close friend of the learner targeted for the secret mode.

As described above, the contents of the secret mode that can be set by the manager include the setting of public and private to the instructor and the friend setting. The manager can set the secret mode to the learner in advance within the range of manager authority. The information set in advance by the manager is stored in the management server 50 as preset information.

[Dedicated Terminal for Secret Mode]

The learner terminal 200 disposed in the specific base 900 such as the education center is a dedicated terminal for the secret mode. Ina case where a learner participates in the remote lesson by using the learner terminal 200, the management server 50 applies the secret mode to the learner.

[Hardware Configuration of Management Server 50]

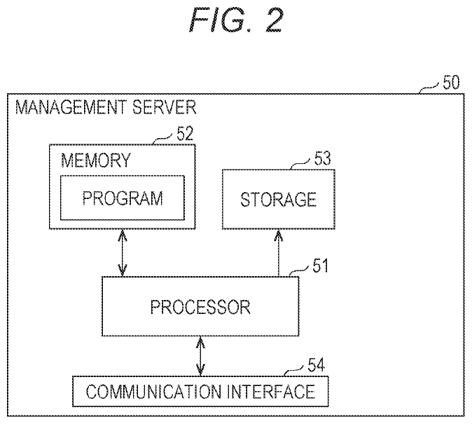

FIG. 2 is a block diagram showing a hardware configuration of the management server 50. The management server 50 includes a processor 51, a memory 52, a storage 53, and a communication interface 54.

The memory 52 includes a read only memory (ROM) and a random access memory (RAM). The storage 53 includes a nonvolatile memory, a hard disk device, and the like. The processor 51 controls operation of the management server 50 by executing a program stored in the memory 52. The storage 53 stores various types of setting information regarding the remote lesson, history information of the remote lesson, and the like.

The management server 50 is connected to the external network 90 via the communication interface 54.

[Functional Configuration of Management Server 50]

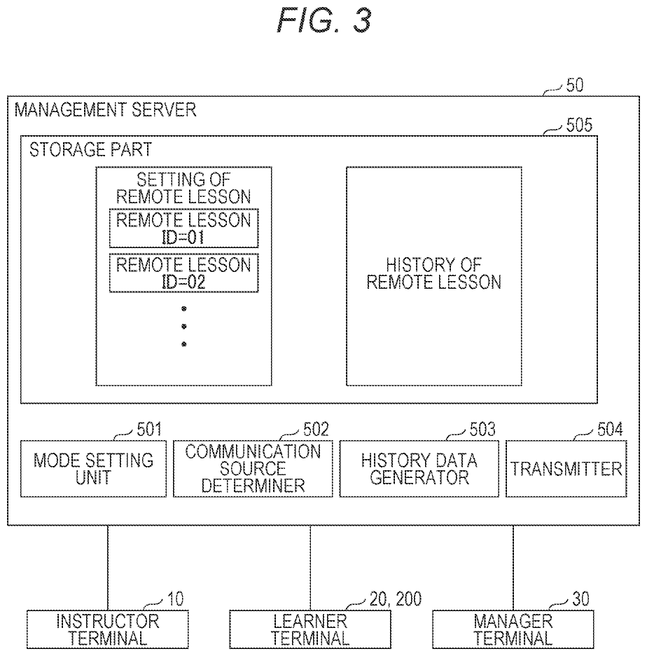

FIG. 3 is a block diagram showing a functional configuration of the management server 50. Various functional configurations shown in FIG. 3 are achieved by the processor 51, the memory 52, the storage 53, and the communication interface 54 shown in FIG. 2.

The management server 50 includes a mode setting unit 501, a communication source determiner 502, a history data generator 503, a transmitter 504, and a storage part 505. The mode setting unit 501 switches the lesson mode of the learner between the standard mode and the secret mode for each learner participating in the remote lesson. The mode setting unit 501 further sets the secret mode in various patterns. The mode set by the mode setting unit 501 is stored in the storage part 505 for each remote lesson ID for identifying the remote lesson as the setting of the remote lesson.

In a case where various terminals access the management server 50, the communication source determiner 502 specifies information of communication sources of the terminals. The information of the communication sources may be, for example, a local IP address or a global IP address. The communication source determiner 502 determines whether the learner terminal 200 disposed in the specific base 900 accesses the management server 50 on the basis of the information of the communication sources. In a case where the learner terminal 200 accesses the management server 50, the communication source determiner 502 notifies the mode setting unit 501 of the user ID used for the access. The mode setting unit 501 sets the secret mode for the learner with the user ID of which notification has been received. As a result, the secret mode is automatically set on the basis of communication source information of the learner who has accessed the management server 50.

The history data generator 503 generates history data of the implemented remote lesson. The history data of the remote lesson includes a participation history that associates the remote lesson in which the learner has participated with the pattern of the secret mode, a participation history of the learner aggregated for each pattern of the secret mode, and the like. The history data generator 503 stores the generated history data in the storage part 505. The transmitter 504 transmits various types of history data for each learner to the learner terminals 20 and 200. Furthermore, the transmitter 504 transmits specific history data to the instructor terminal 10.

[Instructor Setting Screen]

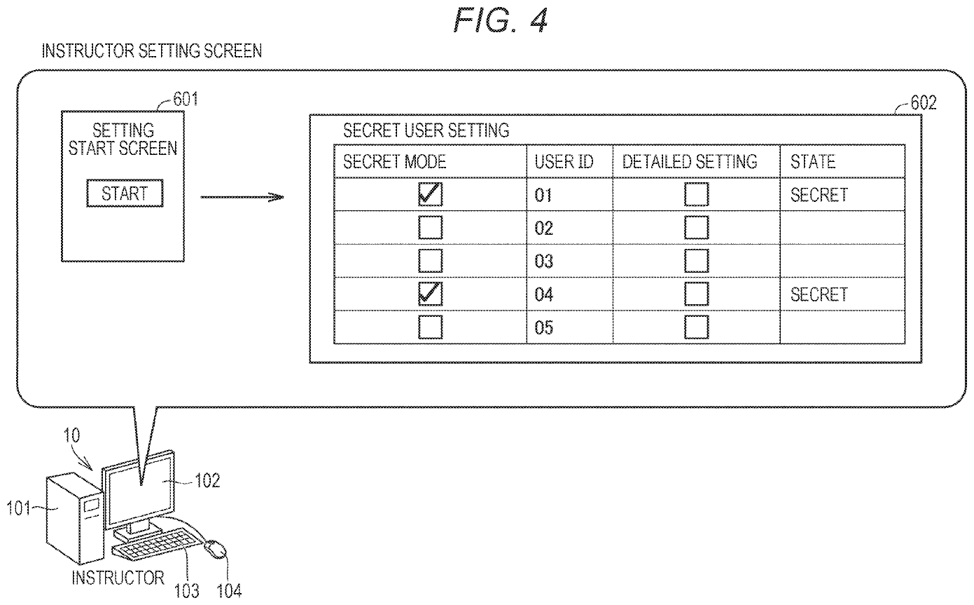

FIG. 4 is a diagram for describing an instructor setting screen. The instructor in charge of the remote lesson sets the secret mode as necessary before conducting the remote lesson. The instructor operates the instructor terminal 10 and accesses the management server 50 to display the setting screen shown in FIG. 4 on the display 102. First, the instructor clicks a start button on a setting start screen 601. Then, the screen is switched to a secret user setting screen 602. On the secret user setting screen 602, a check box of the secret mode and a check box of detailed setting are displayed for each user ID.

The instructor operates the mouse 104 to check the check box of the secret mode corresponding to the user ID of the learner for whom the instructor wants to set the secret mode. Furthermore, in a case where the instructor wants to set details of the secret mode, the instructor checks a check box of the corresponding detailed setting.

FIG. 4 shows a state in which the check boxes of the secret mode corresponding to the user IDs 01 and 04 are checked. However, in FIG. 4, the check boxes of the detailed setting corresponding to the user IDs 01 and 04 are not checked. In this state, the instructor can perform a confirmation operation by operating the mouse 104. The confirmation operation is received by the management server 50. In this case, the secret mode is set to a default state. For example, in the default state, all information of the person set to the secret mode is private to other learners.

Regardless of whether the secret mode is set to the default state or the secret mode is set in various patterns by the detailed setting, the information of the learner is usually open to the instructor in charge of the remote lesson. However, in a case where the manager sets the information of the learner to the instructor to be private in advance, the information of the learner set by the manager is private to the instructor in the remote lesson. That is, in this case, the secret mode functions not only for other learners but also for the instructor.

Here, the secret user setting screen 602 has been described as the setting screen of the instructor. By using a screen similar to the secret user setting screen 602, the management server 50 provides the manager with a function capable of performing setting of the secret user within the range of manager authority. For example, in a case where the manager has authority to the user IDs=01 and 02, a secret user setting screen for the user IDs=01 and 02 may be displayed on the manager terminal 30. By using such a function, the manager can set the secret users for the user IDs=01 and 02 before the instructor sets the secret users by using the secret user setting screen 602. The information set in such a manner is stored in the management server 50 as preset information.

In a case where the preset information exists, the preset information is reflected on the secret user setting screen 602 displayed for the instructor. For example, in a case where the manager has set the secret mode in advance for the user IDs 01 and 02, the secret user setting screen 602 in a display state shown in FIG. 4 is displayed on the instructor terminal 10. In this case, the instructor changes the setting as necessary, for example, further sets the learner with the user ID=02 to the secret mode.

[Instructor Screen (without Private Setting to Instructor)]

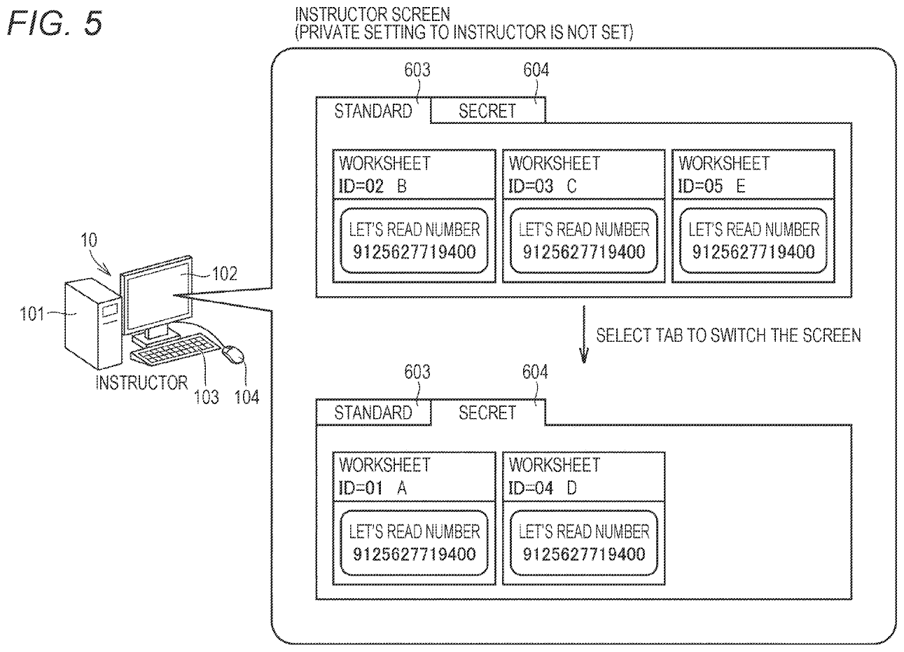

FIG. 5 is a diagram for describing an instructor screen. FIG. 5 shows the instructor screen in a case where secret user setting is performed as shown in FIG. 4. Here, an example of the instructor screen in a case where private setting for the instructor is not performed will be described. In a case where the information of a subject of the secret mode is not set to private to the instructor, the information of the learner set to the standard mode and the information of the learner set to the secret mode are displayed on the display 102 of the instructor terminal 10.

As shown in FIG. 5, the display 102 displays a standard screen 603 that displays information of the learner set to the standard mode and a secret screen 604 that displays information of the learner set to the secret mode. A tab is formed on an upper part of each of the standard screen 603 and the secret screen 604. The instructor can switch the screen displayed on the display 102 between the standard screen 603 and the secret screen 604 by selecting any tab with the mouse 104. In this manner, the instructor terminal 10 displays the information of the learner corresponding to the standard mode and the information of the learner corresponding to the secret mode on different screens.

In secret setting shown in FIG. 4, the first and fourth learners with the user IDs=01 and 04 are set to the secret mode. In this case, as shown in FIG. 5, information of the second learner, the third learner, and the fifth learner with the user IDs=02, 03, and 05 not set to the secret mode is displayed on the standard screen 603.

The standard screen 603 displays the worksheets of the respective learners. The worksheet includes the user ID of the learner and the name of the learner. Personal information such as a face photograph or a video of the corresponding learner may be displayed in the area of the worksheet. Furthermore, an utterance of each learner may be output from the instructor terminal 10 through the speaker.

The secret screen 604 displays the worksheet of each learner set to the secret mode. The worksheet includes the user ID of the learner and the name of the learner. Personal information such as a face photograph or a video of the corresponding learner may be displayed in the area of the worksheet. Furthermore, there is a case where an utterance of each learner set to the secret mode may be output from the instructor terminal 10 through the speaker. However, the personal information such as the user ID, name, and utterance of the learner set to the secret mode is not provided to the learner terminal 20 of other learners.

The instructor progresses the remote lesson while switching the instructor screen to the standard screen 603 and the secret screen 604 as necessary. As described above, in the present embodiment, the instructor screen is divided into the standard screen 603 and the secret screen 604. Therefore, when it is necessary to share the instructor screen with the learner, it is possible to easily perform an operation of excluding the information of the learner set to the secret mode from a sharing target. The present embodiment can prevent a mistake of erroneously setting the information of the learner set to the secret mode as the sharing target.

In particular, in the present embodiment, when one of the standard screen 603 or the secret screen 604 is displayed, the other screen is not displayed, and the screen can be switched by the tab. Therefore, in the present embodiment, when it is necessary to share the screen of the instructor with all the learners, the information of the learners set to the secret mode can be excluded from the sharing target by a simple operation of switching the tab.

[Instructor Screen (with Private Setting to Instructor)]

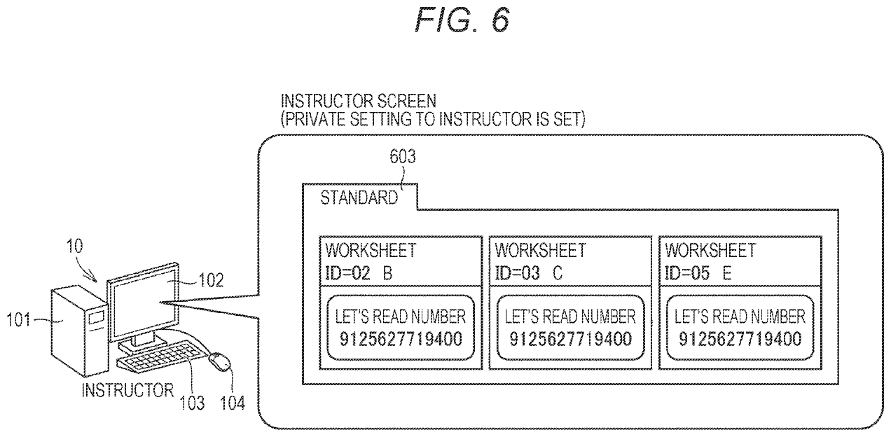

FIG. 6 is a diagram for describing the instructor screen. As in FIG. 5, FIG. 6 shows the instructor screen in a case where secret user setting is performed as shown in FIG. 4. However, here, an example of the instructor screen will be described in a case where the private setting to the instructor is performed for the first and fourth learners of the user IDs=01 and 04 set to the secret mode.

In such a case, the information of the first and fourth learners set to the secret mode is not displayed on the instructor screen. Thus, as shown in FIG. 6, the display 102 of the instructor terminal 10 displays the standard screen 603 including the information of the learner in the standard mode but does not show the secret screen 604. Therefore, in a case where the private setting to the instructor is turned on, for example, not only other learners but also participants who feel stressed about the relationship with the instructor can participate in the remote lesson without reluctance.

Here, a case where private settings of two learners set to the secret mode to the instructor are both turned on has been described. However, there may be a case where only one of the two learners is the learner whose private setting to the instructor is turned on. In this case, the standard screen 603 and the secret screen 604 are displayed on the display 102 of the instructor terminal 10 in a format shown in FIG. 5. However, the information of the learner whose private setting to the instructor is turned on is not displayed on the secret screen 604.

[Learner Screen (ID=01)]

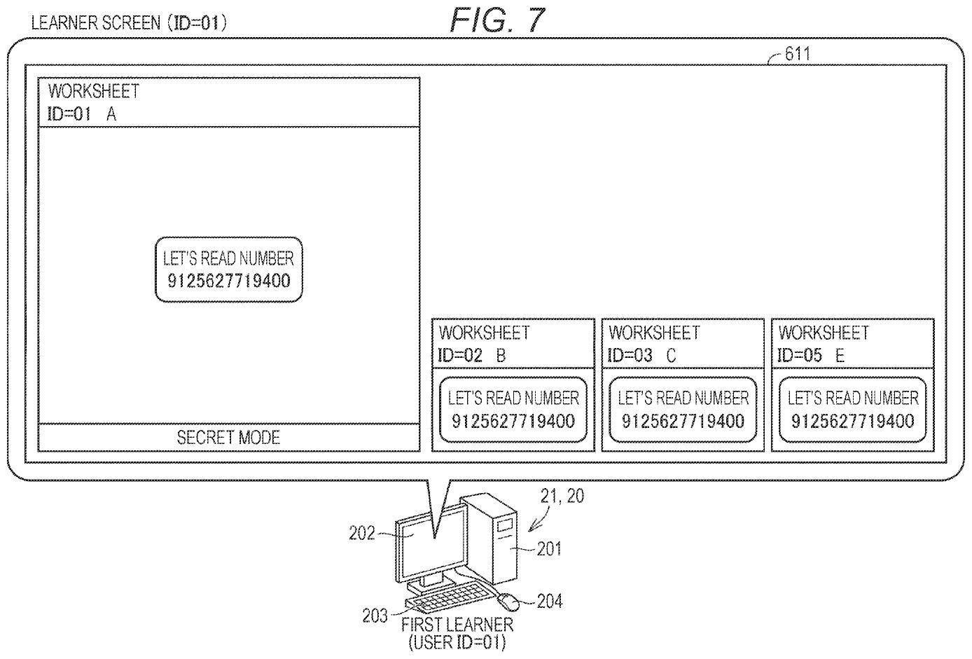

FIG. 7 is a diagram for describing a learner screen 611 corresponding to the user ID=01. FIG. 7 shows the learner screen 611 in a case where the secret user setting is performed as shown in FIG. 4. The first learner identified by the user ID=01 participates in the remote lesson by using the learner terminal 21. Therefore, the learner screen 611 is displayed on the display 202 of the learner terminal 21.

In the setting shown in FIG. 4, the secret mode is set to the first and fourth learners identified by the user IDs=01 and 04. In this case, in addition to their own worksheets, the worksheets of the second, third, and fifth learners who are not set to the secret mode are displayed on the learner screen 611.

Personal information such as the user ID and the name of the learner is also displayed on each of the worksheets. The worksheet of the fourth learner set to the secret mode is not displayed on the learner screen 611. Thus, the information of the fourth learner participating in the remote lesson is not known to the first learner. As a result, the fourth learner set to the secret mode can participate in the remote lesson without reluctance.

As shown in FIG. 7, a message indicating that the mode is the secret mode may be displayed on the worksheet of the learner set to the secret mode. As a result, the learner set to the secret mode can participate in the remote lesson with security.

[Learner Screen (ID=02)]

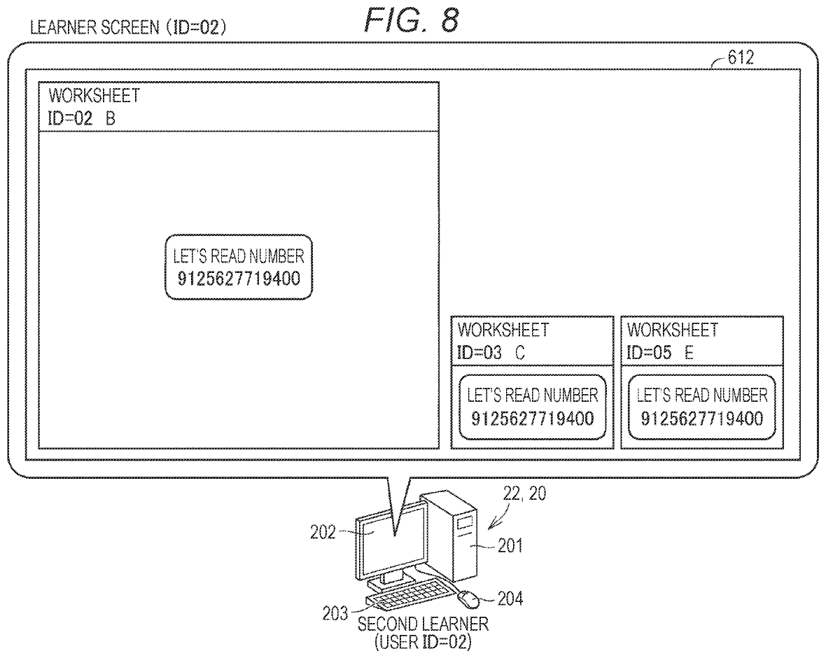

FIG. 8 is a diagram for describing a learner screen 612 corresponding to the user ID=02. FIG. 8 shows the learner screen 612 in a case where the secret user setting is performed as shown in FIG. 4. The second learner identified by the user ID=02 participates in the remote lesson by using the learner terminal 22. Therefore, the learner screen 612 is displayed on the display 202 of the learner terminal 22.

In the setting shown in FIG. 4, the secret mode is set to the first and fourth learners identified by the user IDs=01 and 04. In this case, in addition to their own worksheets, the worksheets of the third and fifth learners who are not set to the secret mode are displayed on the learner screen 612 together with the personal information such as the user ID and the name.

The worksheets of the first and fourth learners set to the secret mode are not displayed on the learner screen 612. Thus, the information of the first and fourth learners participating in the remote lesson is not known to the second learner. As a result, the first and fourth learners set to the secret mode can participate in the remote lesson without reluctance.

[Detailed Setting Items of Secret Mode]

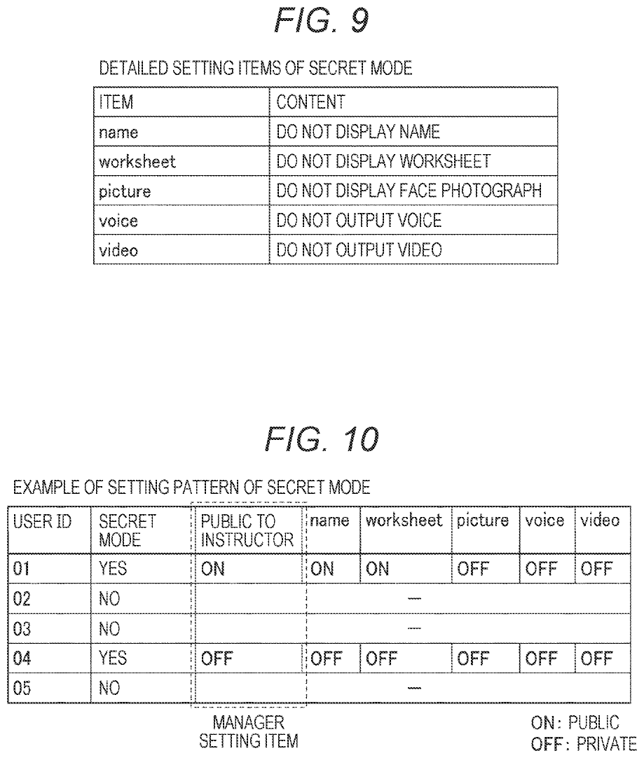

FIG. 9 is a diagram for describing the detailed setting items of the secret mode. The items can be set, for example, in a case where a check box of the detailed setting is checked on the secret user setting screen 602 (see FIG. 4). The detailed setting items include information of learners, which can be set to private in the secret mode. The detailed setting items include “name”, “worksheet”, “picture”, “voice”, and “video”.

In a case where “name” is set to off, the name of the subject is set to be private. In a case where “worksheet” is set to off, the worksheet of the subject is set to be private. In a case where “picture” is set to off, the face photograph of the subject is set to be private. In a case where “voice” is set to off, the voice (utterance and the like) of the subject is set to be private. In a case where “video” is set to off, the video of the subject is set to be private.

In a case where the secret mode is set and the detailed setting items are not set, the secret mode is set to a default state. In this case, all the contents of the detailed setting items are set to be private (off). The management server 50 also provides the manager with a function of setting the detailed setting items described above within the range of manager authority.

### Detailed Example of Patterns of Secret Mode

FIG. 10 is a diagram showing an example of a setting pattern of the secret mode. In this example of setting patters, the secret mode is set to the first and fourth learners identified by the user IDs=01 and 04. In addition to the detailed setting items described with reference to FIG. 9, the setting items of the secret mode include an item on whether to make the information of the learner public to the instructor. The authority to set whether to make the information of the learner public to the instructor is granted only to the manager. Note that the authority to set this item may be granted to the learner himself or herself.

In the example of setting patterns shown in FIG. 10, all the information of the first learner is public to the instructor. According to the example of setting patterns shown in FIG. 10, the name and the worksheet of the first learner are public to other learners, but the face photograph, the voice, and the video of the first learner are private to other learners. For example, such setting patterns configure a first pattern among a plurality of types of patterns of the secret mode.

In the example of setting patterns shown in FIG. 10, all the information of the fourth learner is private to the instructor and other learners. For example, such setting patterns configure a second pattern among the plurality of types of patterns of the secret mode.

The remote lesson support system 1 receives an operation of correcting the set pattern of the secret mode from the manager, the instructor, and the learners. The manager, the instructor, and the learners can modify the set pattern of the secret mode within each scope of granted authority.

[Learner Setting Screen]

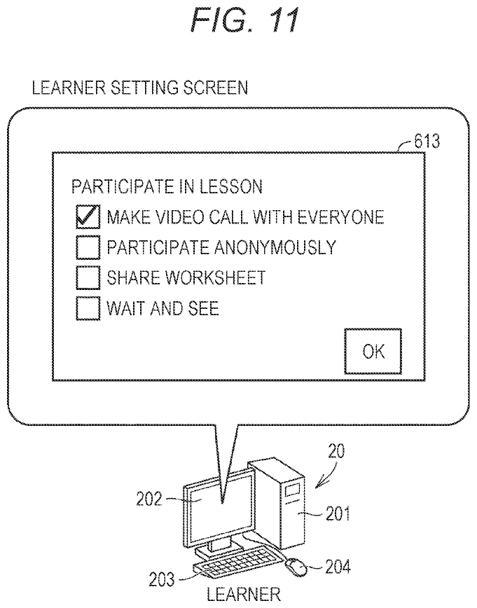

FIG. 11 is a diagram for describing a learner setting screen 613. The management server 50 displays the learner setting screen 613 on the learner terminal 20 during the remote lesson. The learner can change the setting of the secret mode by using the learner setting screen 613.

The learner setting screen 613 displays check boxes respectively corresponding to “make a video call with everyone”, “participate anonymously”, “share the worksheet”, and “wait and see”. When the learner checks one of the check boxes and executes a confirmation operation, the setting in which the check box is checked is validated.

[Relationship Between Learner Setting and Detailed Setting]

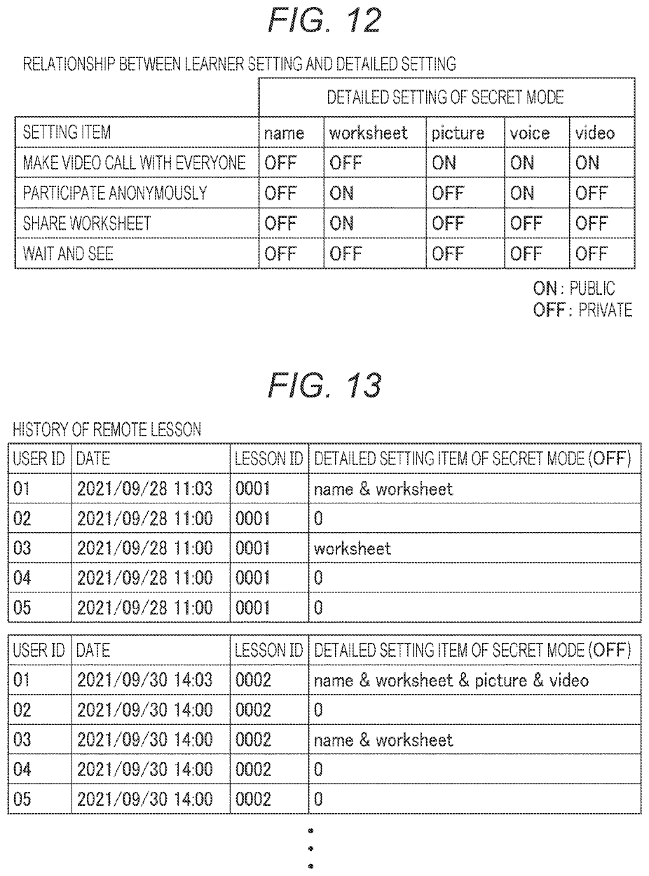

FIG. 12 is a diagram showing a relationship between learner setting and the detailed setting. The relationship between the setting items on the learner setting screen 613 described above and the detailed settings of the secret mode will be described with reference to FIG. 12.

As shown in FIG. 12, in a case where the item “make a video call with everyone” is selected, “name” and “worksheet” are set to off, and “picture”, “voice”, and “video” are set to on among the detailed setting items.

In a case where the item “participate anonymously” is selected, “name”, “picture”, and “video” are set to off, and “worksheet” and “voice” are set to on among the detailed setting items.

In a case where the item “share the worksheet” is selected, only the “worksheet” is set to on and all the other items are set to off among the detailed setting items.

In a case where the item “wait and see” is selected, all the detailed setting items are set to off. That is, when the item “wait and see” is selected, all the information of the learner is made private. This setting is the same as the default setting of the secret mode.

The learner can change the pattern of the secret mode to a pattern according to the situation of the remote lesson and the state of the learner by utilizing the learner setting screen 613 during the remote lesson. Therefore, for example, even a learner who is reluctant to contact with other people can adjust the range of setting the information of the learner to be public according to a mood at that time by utilizing the learner setting screen 613. As a result, the learner can gradually get used to contacting with other people. Note that the setting items on the learner setting screen 613 are merely an example. For example, an item for completely canceling the secret mode and enabling participation in the remote lesson in the standard mode may be added to the learner setting screen 613. Furthermore, an item capable of selecting a range of information public to the instructor may be added to the learner setting screen 613.

[History of Remote Lesson]

FIG. 13 is a diagram showing an example of a history of the remote lesson stored in the management server 50. The management server 50 collects the history of the remote lesson. The management server 50 identifies each remote lesson by the lesson ID.

As shown in FIG. 13, the management server 50 stores the history of the remote lesson for each learner in the storage part 505 by using the lesson ID and the user ID. The history of the remote lesson includes the user ID, the date and time when the learner started to participate in the remote lesson, the lesson ID, and the setting contents of the detailed setting items of the secret mode. In the field of the detailed setting item of the secret mode, items set to be private are displayed. Note that “0” in the field of the detailed setting item of the secret mode means that the mode is not the secret mode.

Referring to the history shown in FIG. 13, it can be seen that the first learner corresponding to the user ID 01 participates in the remote lesson of the lesson ID=01 on Sep. 28, 2021. At that time, it can be seen that the first learner participates in the remote lesson in the secret mode of the pattern in which the name and the worksheet are private.

Referring to the history shown in FIG. 13, it can be seen that the second learner corresponding to the user ID 02 participates in the remote lesson of the lesson ID=01 on Sep. 28, 2021. At that time, it can be seen that the second learner participates in the remote lesson in the standard mode.

The management server 50 classifies the history of the remote lesson for each learner. The management server 50 transmits the classified history of the remote lesson to the learner terminal 20 of the corresponding learner. As a result, each learner can know his or her participation status in the remote lesson. Note that, in a case where a parent of the learner is registered in the remote lesson support system 1 as a manager, the management server 50 may transmit the history of the remote lesson of the child to the manager terminal 30 of the manager.

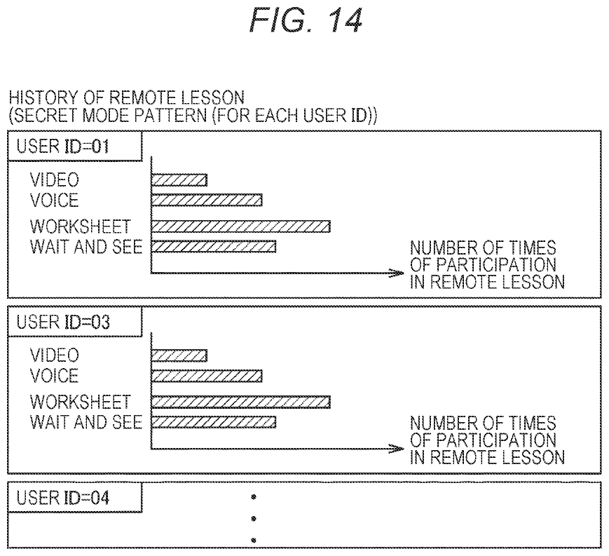

FIG. 14 is a diagram showing an example of the history of the remote lesson (for each user ID and for each secret mode pattern) stored in the management server 50. The management server 50 aggregates the number of times of use of the secret mode for each user ID by using data of the history shown in FIG. 13. As shown in FIG. 14, the management server 50 classifies and aggregates the number of times of use of the secret mode for each pattern of the secret mode. The management server 50 stores the generated counting result in the storage part 505 as the history of the remote lesson separately from the history shown in FIG. 13.

The management server 50 transmits the generated history of the remote lesson to the learner terminal 20 of the corresponding learner. As a result, each learner can know his or her participation status in the remote lesson for each pattern of the secret mode. Note that, in a case where a parent of the learner is registered in the remote lesson support system 1 as a manager, the management server 50 may transmit the history of the remote lesson of the child to the manager terminal 30 of the manager.

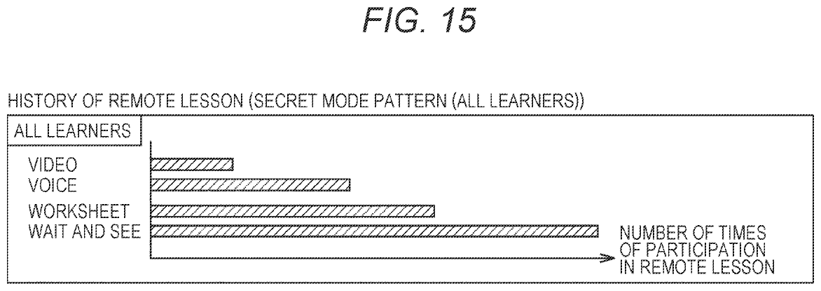

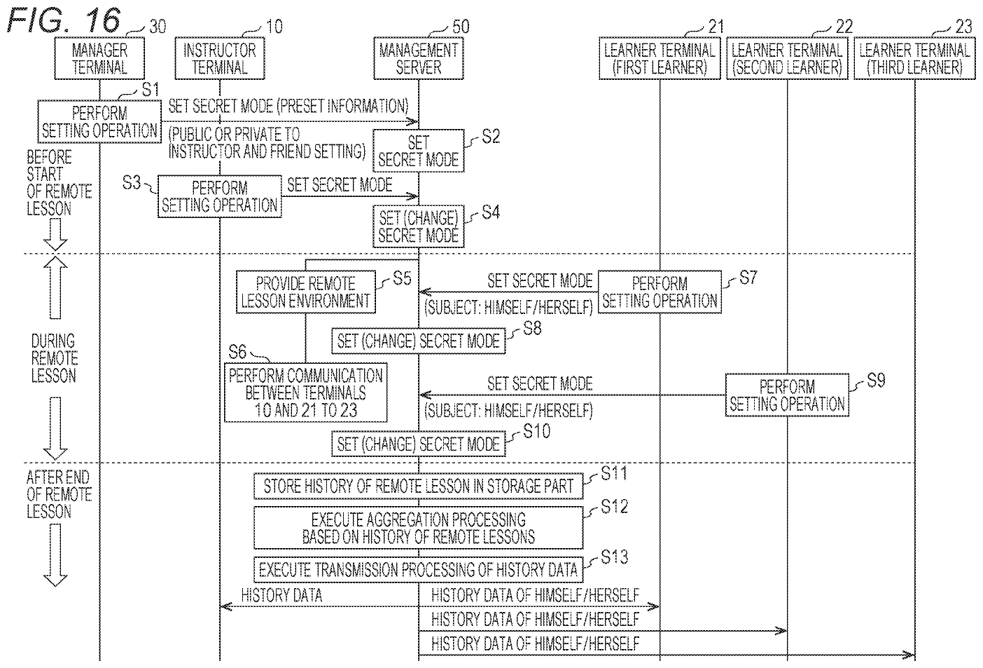

FIG. 15 is a diagram showing an example of the history of the remote lesson (secret mode pattern (all learners)). The management server 50 aggregates the number of times of use of the secret mode of all the learners by using the data of the history shown in FIG. 13 or 14. As shown in FIG. 15, the management server 50 classifies and aggregates the number of times of use of the secret mode for each pattern of the secret mode. The management server 50 stores the generated counting result in the storage part 505 as the history of the remote lesson separately from the history shown in FIG. 13 or 14.

The management server 50 transmits the generated history of the remote lesson to the instructor terminal of the instructor in charge of the remote lesson. As a result, the instructor can know the participation status of the learner who has participated in the remote lesson for each pattern of the secret mode. Note that, in a case where a supervisor of the instructor is registered in the remote lesson support system 1 as a manager, the management server 50 may transmit the history of the remote lesson shown in FIG. 15 to the manager terminal 30 of the manager.

[Flow of Processing Related to Setting of Secret Mode and Generation of History of Remote Lesson]

FIG. 16 is a flowchart for describing a flow of processing related to setting of the secret mode and generation of the history of the remote lesson. Here, an example of timings of processing related to the setting of the secret mode and the generation of the history of the remote lesson described above will be described separately for timings before the start of the remote lesson, during the remote lesson, and after the end of the remote lesson.

[Before Start of Remote Lesson]

The manager operates the manager terminal 30 to set the secret mode within the scope of authority (step S1). As described above, for example, if the manager is a parent of the first learner, the manager is given the authority to set the secret mode related to the first learner.

In addition to the authority to set detailed setting items of the secret mode, the manager is given the authority to set whether to make the information of the learner public or private to the instructor, and the authority to perform the friend setting. A setting operation in step S1 including the above operation is received by the management server 50. The management server 50 sets the secret mode to the targeted learner on the basis of the setting operation in step S1 (step S2). In step S2, the detailed setting item, the friend setting, and the setting of the secret mode including whether there is restriction of information to the instructor are performed. The setting of the secret mode is stored in storage part 505 of the management server 50 as preset information.

The instructor operates the instructor terminal 10 to set the secret mode within the scope of authority (step S3). The instructor is authorized to set the secret mode of the learner participating in the remote lesson of which the instructor is in charge. However, the instructor is not authorized to perform the friend setting and restrict information to the instructor. Note that the instructor may be given the authority to perform the friend setting.

A setting operation in step S3 is received by the management server 50. The management server 50 sets the secret mode to the targeted learner on the basis of the setting operation in step S3 (step S4). The preset information is changed in accordance with the setting content. The updated setting of the secret mode is stored in storage part 505 of the management server 50. As described above, the setting work of the secret mode before the start of the remote lesson ends.

[During Remote Lesson]

At the time of the remote lesson, the instructor and each learner log in to the management server 50 from their own terminals, and the remote lesson is started. The management server 50 provides an environment of the remote lesson to the instructor terminal 10 and the learner terminal 20 (21 to 23) (step S5). As a result, communication for the remote lesson is started between the instructor terminal 10 and the learner terminals 21 to 23 (step S6). The instructor terminal 10 and the learner terminal 20 display a screen corresponding to the setting of the secret mode. For example, in this remote lesson, it is assumed that the first and second learners corresponding to each of the user IDs 01 and 02 are set to the secret mode.

The learner terminal 21 of the first learner displays the learner setting screen 613 (see FIG. 11). The first learner can change the setting of his or her own secret mode by using the learner setting screen 613 in the middle of the remote lesson (step S7). A setting operation in step S7 is received by the management server 50. The management server 50 changes the setting of the secret mode of the targeted learner on the basis of the setting operation in step S7 (step S8). In step S8, the setting of the detailed setting item of the secret mode is changed. The changed setting of the secret mode is stored in storage part 505 of the management server 50.

The second learner can also change the setting of his or her own secret mode in a similar manner (steps S9 and S10). In this manner, the first and second learners attend the lesson while changing the setting of their own secret mode as necessary.

[After Remote Lesson]

When the remote lesson ends, the management server 50 generates history data of the remote lesson and stores the history data in the storage part 505 together with the lesson ID and the user ID of the participant (step S11). Accordingly, the history data exemplified in FIG. 13 is accumulated in the storage part 505. The management server 50 reads history data of a large number of remote lessons accumulated in the storage part 505 and executes aggregation processing (step S12). As a result, the history data (aggregated data) exemplified in FIGS. 14 and 15 is generated, and the generated data is accumulated in the storage part 505.

The management server 50 refers to the storage part 505 and executes history data transmission processing (step S13). As a result, the history data of the remote lesson is transmitted to the learner terminals 21 to 23 and the instructor terminal 10. However, the history data transmitted to the learner terminals 21 to 23 is different from the history data transmitted to the instructor terminal 10.

The learner's own history data in the aspects shown in FIGS. 13 and 14 is transmitted to the learner terminals 21 to 23. The transmitted data is only data corresponding to the user ID of the learner. Thus, the first to third learners can check their own histories of the remote lessons. The history data shown in FIG. 15 is transmitted to the instructor terminal 10. As a result, the instructor can know a participation pattern of the participant participating in the remote lesson.

[Manager Setting Processing]

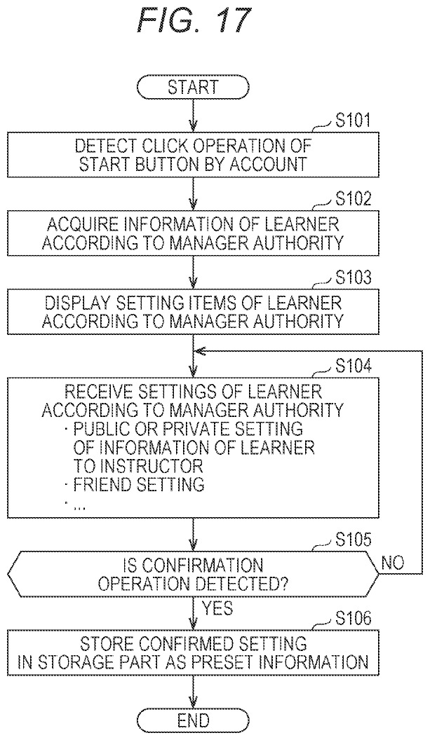

FIG. 17 is a flowchart for describing a flow of manager setting processing. Here, a flow of processing in which the management server 50 sets the secret mode in accordance with the operation of the manager terminal 30 will be described with reference to FIG. 17. The processing based on this flowchart is mainly executed by the mode setting unit 501 (see FIG. 3).

The manager terminal 30 displays a setting screen for setting the secret mode. The setting screen includes a start button for starting the setting. The manager who sets the secret mode clicks the start button.

The management server 50 detects a click operation of the start button by the manager's account (step S101). Next, the management server 50 acquires information of the learner according to the manager authority (step S102). The information of the learner according to the manager authority includes the user ID of the learner and the like. Next, the management server 50 displays setting items of the learner according to the manager authority on the manager terminal 30 on the basis of the acquired information (step S103). The setting items include whether the secret mode is set, detailed setting items of the secret mode, public and private setting of the information of the learner to the instructor, friend setting, and the like.

The manager terminal 30 displays a screen for setting the above. The manager sets necessary items while viewing the screen. The management server 50 receives various settings of the learner according to the manager authority, including public and private setting of the information of the learner to the instructor and the friend setting (step S104).

When the setting is completed, the manager operating the manager terminal 30 executes a confirmation operation on the setting screen. The management server 50 repeats the processing of step S104 until the confirmation operation is detected. In a case where detecting the confirmation operation (YES in step S105), the management server 50 stores the confirmed setting in the storage part 505 as preset information, and ends the processing based on the flowchart.

[Instructor Setting Processing]

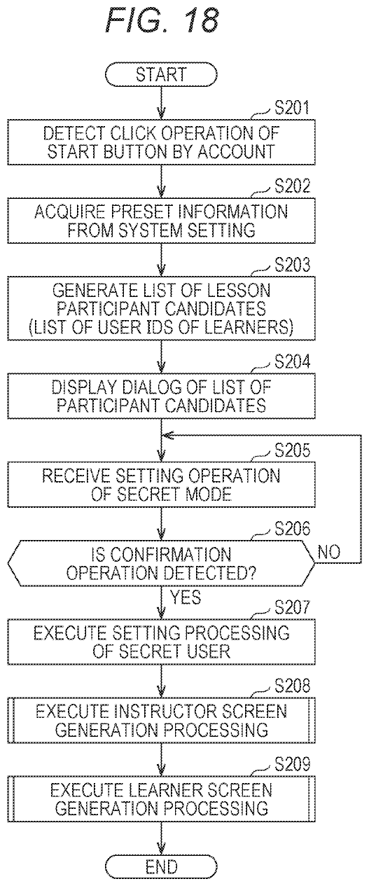

FIG. 18 is a flowchart for describing a flow of instructor setting processing. Here, a flow of processing in which the management server 50 sets the secret mode in accordance with the operation of the instructor terminal will be described with reference to FIG. 18. The processing based on this flowchart is mainly executed by the mode setting unit 501 (see FIG. 3).

The instructor terminal 10 displays a setting screen for setting the secret mode. The setting screen includes a start button for starting the setting. The instructor who sets the secret mode clicks the start button.

The management server 50 detects a click operation of the start button by the instructor's account (step S201). Next, the management server 50 acquires preset information from system setting (step S202). The preset information is set in step S106, for example, in accordance with an operation of the manager.

Next, the management server 50 generates a list of lesson participant candidates (a list of user IDs of learners) (step S203), and displays a dialog of the list of participant candidates on the instructor terminal 10 on the basis of the generated data (step S204). As a result, the instructor terminal 10 displays the screen shown in FIG. 4. Next, the management server 50 receives a setting operation of the secret mode by the instructor (step S205). The target of the setting operation of the secret mode includes whether the secret mode is shown in FIG. 4 is set and includes setting of the detailed setting items shown in FIG. 9.

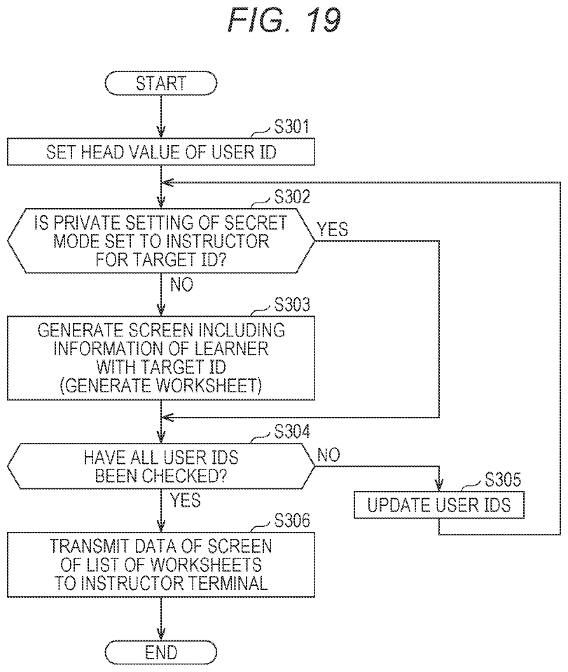

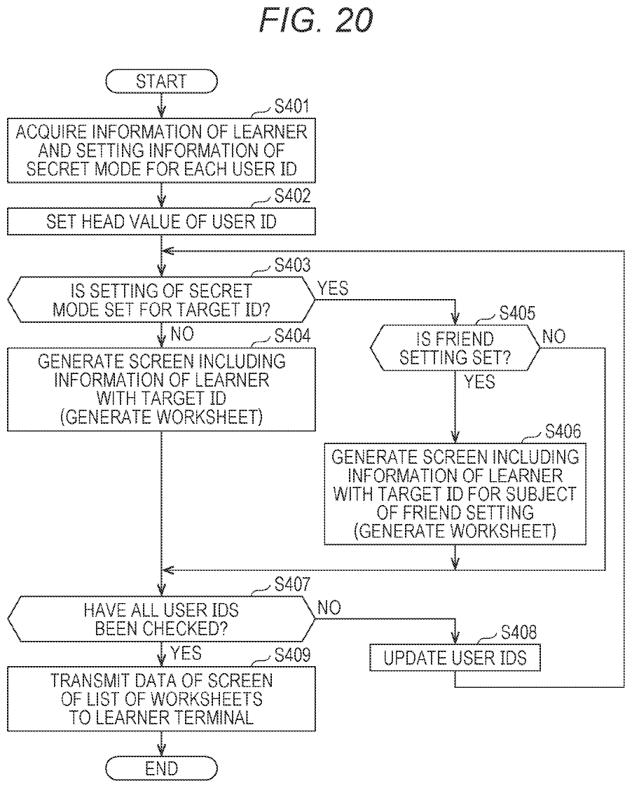

When the setting is completed, the instructor operating the instructor terminal 10 executes a confirmation operation on the setting screen. The management server 50 repeats the processing of step S205 until the confirmation operation is detected. In a case where detecting the confirmation operation (YES in step S206), the management server 50 executes setting processing for the secret user (step S207), and stores the confirmed setting in the storage part 505. Next, processing of generating a screen for the instructor and a screen for the learner corresponding to the confirmed settings is executed (steps S208 and S209), and the processing based on the flowchart ends. Details of the processing of generating the screen for the instructor will be described with reference to FIG. 19, and details of the processing of generating the screen for the learner will be described with reference to FIG. 20.

[Instructor Screen Generation Processing]

FIG. 19 is a subroutine for describing a flow of instructor screen generation processing. The management server 50 first sets a head value of the user ID (step S301). For example, here, the user ID is set to 01. Next, the management server 50 determines whether private setting of the secret mode to the instructor is set for the target ID (set ID) (step S302).

In a case where the private setting of the secret mode to the instructor is not set, the management server 50 generates a screen including the information of the learner with the target ID (step S303). As a result, a worksheet including information (such as name) of the learner with the target ID is generated. The worksheet generated here constitutes, for example, a worksheet screen of each learner shown in FIG. 5.

In a case where the private setting of the secret mode to the instructor is set, the management server 50 does not generate a screen including the information of the learner with the target ID. As a result, the information of the learner with the target ID is not displayed on the instructor screen.

Next, the management server 50 determines whether all the user IDs have been checked (step S304). In a case where not all the user IDs have been checked, the management server 50 updates the user IDs (step S305). For example, in a case where the target ID is 01, the next target ID is updated to 02 in step S305. The management server 50 executes the processing in and after step S302 on the basis of the updated ID. By repeating such processing, the management server 50 determines whether to generate a screen including the information of the learner for all the user IDs, and generates the screen in accordance with a result of the determination.

In a case where it is determined in step S304 that all the user IDs have been checked, the management server 50 transmits data of the generated screen of a list of worksheets to the instructor terminal 10 (step S306). As a result, the instructor terminal 10 displays the instructor screen exemplified in FIGS. 5 and 6.

[Learner Screen Generation Processing]

FIG. 20 is a subroutine for describing a flow of learner screen generation processing. The management server 50 first acquires the information of the learner and the setting information of the secret mode for each user ID (step S401). Next, the management server 50 sets a head value of the user ID (step S402). For example, here, the user ID is set to 01. Subsequently, the management server 50 determines whether the secret mode is set for the target ID (set ID) (step S403). Here, a case where the secret mode is default setting, that is, a case where all the detailed setting items are set to be private is taken as an example.

In a case where setting of the secret mode is not set, the management server 50 generates a screen including the information of the learner with the target ID (step S404). As a result, a worksheet including information (such as name) of the learner with the target ID is generated. The worksheet generated here constitutes, for example, a worksheet screen of each learner shown in FIGS. 7 and 8.

In a case where the secret mode is set, the management server 50 determines whether the friend setting is set for the target ID (step S405). In a case where the friend setting is set, the management server 50 generates a screen including information of the learner with the target ID for the subject of the friend setting (step S406). For example, in a case where the first learner with ID=01 is set to the secret mode, the management server 50 prevents information of the first learner from being displayed on a screen for other learners. However, in a case where the friend setting is set, the management server 50 exceptionally displays the information of the first learner on the screen for the learner targeted for the friend setting.

In a case where the secret mode is set and the friend setting does not exist for the target ID, the management server 50 does not generate the screen including the information of the learner of the target ID. As a result, the information of the learner with the target ID is not displayed on the learner screen.

Next, the management server 50 determines whether all the user IDs have been checked (step S407). In a case where not all the user IDs have been checked, the management server 50 updates the user IDs (step S408). For example, in a case where the target ID is 01, the next target ID is updated to 02 in step S408. The management server 50 executes the processing in and after step S403 on the basis of the updated ID. By repeating such processing, the management server 50 determines whether to generate a screen including the information of the learner for all the user IDs, and generates the screen in accordance with a result of the determination.

In a case where it is determined in step S407 that all the user IDs have been checked, the management server 50 transmits data of the generated screen of a list of worksheets to the learner terminal 20 (step S409). As a result, the learner terminal 20 displays the learner screen exemplified in FIGS. 7 and 8.

### Modification

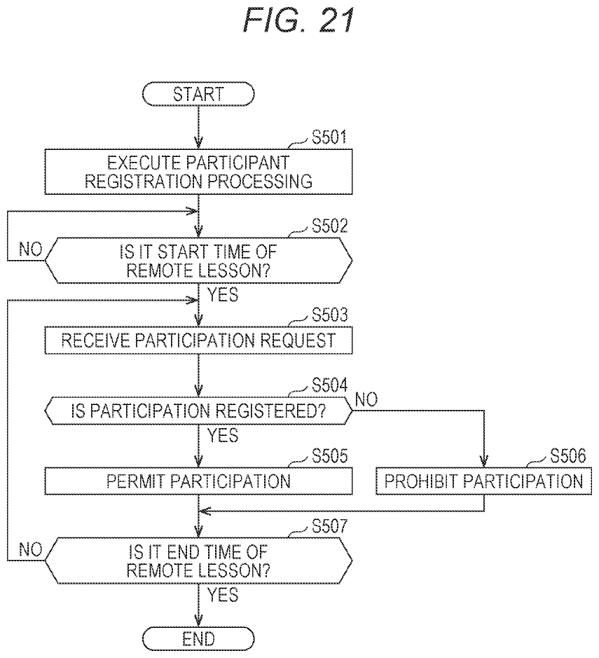

FIG. 21 is a flowchart for describing a flow of participant restriction processing according to a modification. Here, as a modification, processing of limiting the members who can participate in the remote lesson to previously registered persons will be described.

In the modification, a learner who can participate in the remote lesson is registered in advance as a member of a class. This registration corresponds to registration of participation in the lesson. The registered learner is authorized to participate in the remote lesson of the class as a participant. Unregistered learners (learners outside of the class) are not authorized to participate in the remote lesson. The registered learner is allowed to set and cancel the secret mode as described above.

Hereinafter, a flow of processing for achieving such control will be described with reference to a flowchart of FIG. 21. The processing based on this flowchart is executed by the management server 50.

First, the management server 50 executes participant registration processing (step S501). The participant registration processing is processing of registering a learner who can participate in the remote lesson in accordance with an operation of a registration authorized person as a member of the class of the remote lesson in advance. In the participant registration processing, for example, the management server 50 registers the user ID of the subject and the like. The registration authorized person is, for example, a teacher in charge of the remote lesson. After finishing the participant registration processing, the management server 50 waits until a start time of the remote lesson for which the participant registration processing has been performed.

At the start time of the remote lesson for which the participant registration processing has been performed (YES in step S502), the management server 50 receives a participation request from a participation applicant to the remote lesson (step S503). The participation request may be sent from a registered participant in the participant registration processing or may be sent from an external person not registered in the participant registration processing. The management server 50 determines whether the received participation request is sent from the registered participant in the participant registration processing (step S504). Specifically, the management server 50 determines whether the user ID included in the participation request is registered by the participant registration processing.

In a case where determining that the user ID included in the participation request is registered by the participant registration processing, the management server 50 permits the participation requester to participate in the remote lesson (step S505). In a case where determining that the user ID included in the participation request is not registered by the participant registration processing, the management server 50 prohibits the participation requester to participate in the remote lesson (step S506).

Next, the management server 50 determines whether it is an end time of the remote lesson (step S507). In a case where it is not the end time of the remote lesson, the management server 50 returns to step S503 and executes processing of receiving the participation request. In a case where determining that it is the end time of the remote lesson, the management server 50 ends the processing based on the flowchart.

By applying the modification described above to the above embodiment, it is possible to prevent inconvenience caused by participation of a member not assumed in advance in the remote lesson. For example, in a case where the present modification is applied to the flowchart shown in FIG. 16, the first to third learners are permitted to participate in the remote lesson on condition that the first to third learners are registered as participants in advance by the participant registration processing.

Note that a learner outside the class that is not registered in advance may be able to participate in the remote lesson as a guest or by post-provisional registration. However, a guest or a person who participates through provisional registration is desirably not allowed to participate in the standard mode, unlike the officially registered participant.

[Program]

A program for causing the management server 50 to execute the above processing is stored in the memory 52 of the management server 50. Such a program includes at least a program according to the flowcharts shown in FIGS. 16 to 20. The program can also be provided as a program product by being recorded on a computer-readable recording medium such as a flexible disk, a compact disk read only memory (CD-ROM), a ROM, a RAM, or a memory card attached to the computer of the management server 50. Alternatively, the program can be provided by being recorded on a recording medium such as a hard disk built in the computer. Alternatively, the program can be provided by being downloaded via a network. The program may be executed by one or more processors such as a CPU, or by a combination of a processor and a circuit such as an ASIC or an FPGA.

Note that the program may call a necessary module in a predetermined array at a predetermined timing among program modules provided as a part of an operating system (OS) of the computer, and cause the processor to execute processing. In that case, the program itself does not include the module, and the processing is executed in cooperation with the OS. Such a program not including a module can also be included in the program according to the present embodiment.

In addition, the program according to the present embodiment may be provided by being incorporated in a part of another program. Also in this case, the program itself does not include the module included in another program described above, and causes the processor to execute processing in cooperation with another program. Such a program incorporated in another program can also be included in the program according to the present embodiment.

### ASPECTS

Aspects of the present disclosure are listed below.

(Section 1) A remote lesson support system (1) according to Section 1 supports a remote lesson in which a plurality of learners participates via a network, the remote lesson support system (1) including a first terminal (21) operated by a first learner, a second terminal (22) operated by a second learner, and a server (50) that is communicably connected to the first terminal and the second terminal and provides an environment of the remote lesson, in which the server includes a processing device (51) that sets a secret mode that restricts information of the first learner from being provided to the second terminal.

(Section 2) The remote lesson support system according to Section 1 further includes an instructor terminal (10) operated by an instructor in charge of the remote lesson, in which the server is able to restrict the information of the first learner from being provided to the instructor terminal in the secret mode (FIG. 10).

(Section 3) In the remote lesson support system according to Section 2, the server is able to provide the information of the first learner to the instructor terminal in the secret mode (FIG. 5).

(Section 4) In the remote lesson support system according to any one of Sections 1 to 3, the processing device sets the secret mode in a plurality of types of patterns (FIG. 9), and the plurality of types of patterns includes a first pattern that prohibits first information of the first learner from being provided and permits second information of the first learner to be provided (for example, prohibits a video of the first learner from being provided and permits the name of the first learner to be provided), and a second pattern that permits the first information of the first learner to be provided and permits the second information of the first learner to be provided (for example, prohibits the name of the first learner from being provided and permits the vide of the first learner to be provided).

(Section 5) In the remote lesson support system according to any one of Sections 1 to 4, the processing device sets the secret mode on the basis of an operation of the first terminal (FIG. 11).

(Section 6) In the remote lesson support system according to Section 4, the server further includes a storage part (505) that stores a history of the remote lesson, and the processing device generates a participation history of the first learner, the participation history associating the remote lesson in which the first learner has participated with the patterns of the secret mode, and the processing device stores the participation history of the first learner in the storage part as the history of the remote lesson (FIG. 13).

(Section 7) In the remote lesson support system according to Section 6, the processing device aggregates the participation history of the first learner for each of the patterns of the secret mode, and further stores aggregated data in the storage part as the history of the remote lesson (FIG. 14).

(Section 8) In the remote lesson support system according to Section 6, the processing device provides the history of the remote lesson of the first learner stored in the storage part to the first terminal (step S13 in FIG. 16).

(Section 9) The remote lesson support system according to any one of Sections 1 to 8 further includes a manager terminal operated by a manager, in which the processing device sets the secret mode on the basis of an operation of the manager terminal (steps S1 and S2 in FIG. 16).

(Section 10) In the remote lesson support system according to Section 3, the instructor terminal displays the information of the first learner and information of the second learner on different screens in a case where the secret mode is set (FIG. 5).

(Section 11) In the remote lesson support system according to Section 2, the processing device sets the secret mode on the basis of an operation of the instructor terminal (steps S3 and S4 in FIG. 16).

(Section 12) In the remote lesson support system according to Section 6, the processing device aggregates the participation history of each of two or more learners including the first learner for each of the patterns of the secret mode, and further stores aggregated data in the storage part as the history of the remote lesson (FIG. 14).

(Section 13) The remote lesson support system according to any one of Sections 1 to 12 further includes a third terminal (23) operated by a third learner, in which the processing device determines whether to restrict the information of the first learner from being provided to the third terminal when setting a mode of the remote lesson to the secret mode (friend setting in step S406 in FIG. 20).

(Section 14) In the remote lesson support system according to any one of Sections 1 to 13, the processing device automatically sets the secret mode on the basis of communication source information (a local IP address or a global IP address) of a learner who has accessed the server (communication source determiner 502).

(Section 15) In the remote lesson support system according to any one of Sections 1 to 14, the server is able to execute registration processing of registering a participant in the remote lesson, and the server permits the first learner and the second learner to participate in the remote lesson in a case where the first learner and the second learner are registered as participants in the remote lesson by the registration processing (FIG. 21).

(Section 16) A method of supporting a remote lesson in which a plurality of learners participates via a network includes communicating with a first terminal operated by a first learner and a second terminal operated by a second learner (step S6 in FIG. 16), providing an environment of the remote lesson (step S5 in FIG. 16), and setting a secret mode that restricts information of the first learner from being provided to the second terminal (steps S2, S4, S8, and S10 in FIG. 16).

(Section 17) A non-transitory recording medium storing a computer readable program causes a computer to execute the method according to Section 16.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all modifications within the scope are included.

What is claimed is:

1. A remote lesson support system that supports a remote lesson in which a plurality of learners participates via a network, the remote lesson support system comprising:
a first terminal operated by a first learner;
a second terminal operated by a second learner; and
a server that is communicably connected to the first terminal and the second terminal and provides an environment of the remote lesson, wherein
the server includes a processing device that sets a secret mode that restricts information of the first learner from being provided to the second terminal.

2. The remote lesson support system according to claim 1, further comprising an instructor terminal operated by an instructor in charge of the remote lesson, wherein the server is able to restrict the information of the first learner from being provided to the instructor terminal in the secret mode.

3. The remote lesson support system according to claim 2, wherein the server is able to provide the information of the first learner to the instructor terminal in the secret mode.

4. The remote lesson support system according to claim 1, wherein
the processing device sets the secret mode in a plurality of types of patterns, and
the plurality of types of patterns includes a first pattern that prohibits first information of the first learner from being provided and permits second information of the first learner to be provided, and a second pattern that permits the first information of the first learner to be provided and permits the second information of the first learner to be provided.

5. The remote lesson support system according to claim 1, wherein the processing device sets the secret mode on a basis of an operation of the first terminal.

6. The remote lesson support system according to claim 4, wherein
the server further includes a storage part that stores a history of the remote lesson, and
the processing device generates a participation history of the first learner, the participation history associating the remote lesson in which the first learner has participated with the patterns of the secret mode, and the processing device stores the participation history of the first learner in the storage part as the history of the remote lesson.

7. The remote lesson support system according to claim 6, wherein the processing device aggregates the participation history of the first learner for each of the patterns of the secret mode, and further stores aggregated data in the storage part as the history of the remote lesson.

8. The remote lesson support system according to claim 6, wherein the processing device provides the history of the remote lesson of the first learner stored in the storage part to the first terminal.

9. The remote lesson support system according to claim 1, further comprising a manager terminal operated by a manager, wherein the processing device sets the secret mode on a basis of an operation of the manager terminal.

10. The remote lesson support system according to claim 3, wherein the instructor terminal displays the information of the first learner and information of the second learner on different screens in a case where the secret mode is set.

11. The remote lesson support system according to claim 2, wherein the processing device sets the secret mode on a basis of an operation of the instructor terminal.

12. The remote lesson support system according to claim 6, wherein the processing device aggregates the participation history of each of two or more learners including the first learner for each of the patterns of the secret mode, and further stores aggregated data in the storage part as the history of the remote lesson.

13. The remote lesson support system according to claim 1, further comprising a third terminal operated by a third learner, wherein the processing device determines whether to restrict the information of the first learner from being provided to the third terminal when setting a mode of the remote lesson to the secret mode.

14. The remote lesson support system according to claim 1, wherein the processing device automatically sets the secret mode on a basis of communication source information of a learner who has accessed the server.

15. The remote lesson support system according to claim 1, wherein
the server is able to execute registration processing of registering a participant in the remote lesson, and
the server permits the first learner and the second learner to participate in the remote lesson in a case where the first learner and the second learner are registered as participants in the remote lesson by the registration processing.

16. A method of supporting a remote lesson in which a plurality of learners participates via a network, the method comprising:
communicating with a first terminal operated by a first learner and a second terminal operated by a second learner;
providing an environment of the remote lesson; and
setting a secret mode that restricts information of the first learner from being provided to the second terminal.

17. A non-transitory recording medium storing a computer readable program for causing a computer to execute the method according to claim 16.
